(19) United States
(12) Patent Application Publication
(10) Pub. No.: US 2003/0187868 A1
(43) Pub. Date: Oct. 2, 2003

(54) Data acquisition system

(75) Inventor: Norihiko Igarashi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/284,118

(22) Filed: Oct. 31, 2002

(30) Foreign Application Priority Data
Mar. 29, 2002 (JP) 2002-093605

(51) Int. Cl. G06F 17/30

(52) U.S. Cl. 707/102

(57) ABSTRACT

The present invention comprises content management means for receiving the entry of content from user terminals, receiving content requests from user terminals, and extracting other user terminals possessing the request target content, connection condition management means for monitoring connection conditions of user terminals, and terminal management means for determining the connection conditions of an extracted terminal, and if the terminal is on-line, sending a request to the terminal so as to start content transfer, and if the terminal is off-line, holding the request in the connection conditions management means, acquiring connection conditions for the extracted terminal, and sending the connection conditions to the request source terminal.

### BACKGROUND OF THE INVENTION

1. Field of the Invention

This invention relates to a system for acquiring data via a network, and more specifically to a system for data exchange between terminals in peer-to-peer on a network, namely, a data acquisition system where terminals exchange data with each other.

2. Description of the Related Art

When data is exchanged between two terminals in peer-to-peer, it is necessary for both the request destination terminal and the request source terminal to be in an on-line state meaning a state where a terminal is connected to the network. There are therefore situations where the desired data cannot be acquired due to connection timing not being compatible depending on the operating conditions of the terminals. Situations therefore occur where an extremely long period of time is required until file transfer is complete due to the connection state and operating conditions such as the bandwidth conditions or the like of the request destination terminal.

A file name, which is one of information that the data is identified, can be arbitrarily designated by the user saving the data. Therefore, even if data corresponding to the desired data exists, the whereabouts of the data cannot be known from the file name and the desired data still cannot be acquired by somebody other than the owner of the data.

### SUMMARY OF THE INVENTION

It is therefore an object of the present invention to provide a system capable of alleviating difficulties during data acquisition due to discrepancies in connection states by making it possible to select more times when the request source is able to acquire data.

It is a further object of the present invention to bring about a system capable of alleviating difficulties during data acquisition due to discrepancies in connection states by ensuring that a data request source is aware of the whereabouts of data having the same content but having different names.

The present invention therefore provides a data acquisition system for carrying out acquisition of data between terminals on a network, comprising a data management table for storing data held by terminals in such a manner that terminals holding the data correspond, terminal management means for determining whether or not a data acquisition request source terminal and a request destination terminal are in an on-line state of being connected to the network, or are in an off-line state of not being connected to the network, connection conditions management means for acquiring a connection log for the request destination terminal and managing connection conditions for each item of data of the request data destination terminal, and data management means for, when a data acquisition request is received from the request source terminal, extracting the terminal holding target data of the data acquisition request as a request destination terminal, and when the request destination terminal is on-line, sending the data acquisition request to the request destination terminal and starting transfer of the request target data, and when the request destination terminal is off-line, holding the data acquisition request as a waiting request, acquiring connection conditions corresponding to the request destination terminal, and sending the connection conditions to the request source terminal.

When the aforementioned structure is adopted in the present invention, the data management table stores a data name, size and hash value of data possessed by the terminals, and the data management means extracts a terminal holding data that is the same size and hash value as the target data of the data acquisition request as a request destination terminal.

In the present invention, the data name, size, and hash value of data held by the terminal is stored in advance in the data management table in such a manner as to correspond with the terminals holding the data by the data management means. The connection conditions management means acquires the logs for connecting to the terminals and stores and manages the connection conditions for each item of data of the terminals.

When a data acquisition request is received from a request source terminal, terminals holding the target data of the data acquisition request is extracted from the data management table by the data management means as request destination terminals, and a terminal holding data that is the same size and hash value as the target data of the data acquisition request is extracted as a request destination terminal. The terminal management means then determines whether the data acquisition request source terminal and request destination terminal are in an on-line or off-line state, and when the request destination terminal is in the on-line state, the data acquisition request is sent to the request destination terminal and data transfer of the request target is started.

On the other hand, when the request destination terminal is in the off-line state, the data acquisition request is held as a request waiting, the connection conditions corresponding to the request destination terminal are acquired, and the connection conditions are sent to the request source terminal.

### BRIEF DESCRIPTION OF THE DRAWINGS

FIG. 1 is a view showing an outline of a configuration for a system for an embodiment of the present invention.

FIG. 2 is a view showing an example configuration for a content manager and the relationship of correspondence between a content manager and user terminals.

FIG. 3 is a view showing an example of a content management table.

FIG. 4 is a view showing an example of a connection state management table.

FIG. 5 is a view showing an example of a request window.

FIG. 6 is a view showing an example of a search results window.

FIG. 7 is a view showing an example window for when connection is awaited shown when the user terminal is in the off-line state.

FIG. 8 is a view showing an example window for when the user terminal is in the on-line state and it is possible to start connection.

FIG. 9 is a view showing an example window for when the user terminal is in the on-line state and connection is awaited.

FIG. 10 is a view showing the process flow of the present invention.

### DETAILED DESCRIPTION OF THE PREFERRED EMBODIMENT

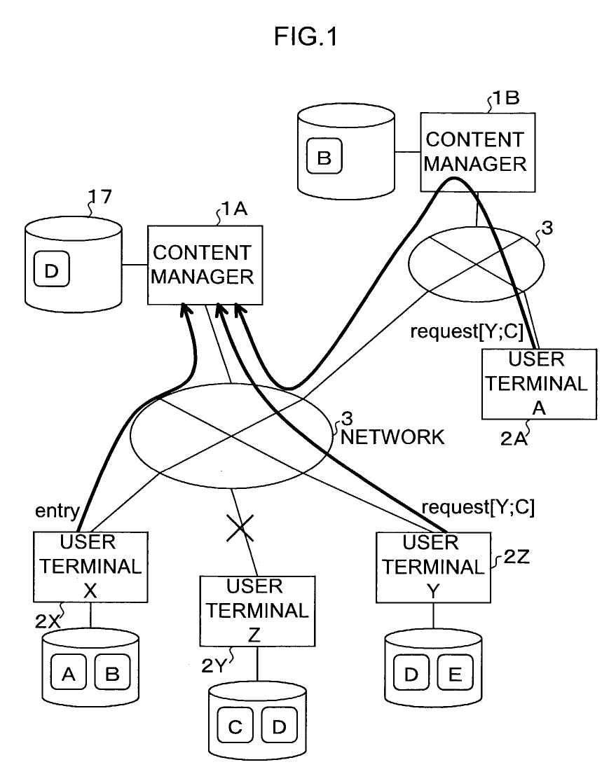

FIG. 1 shows an outline of a configuration for a system for an embodiment of the present invention. This system comprises a content manager 1A and user terminals 2X, 2Y, 2Z, permitted in advance to access the content manager 1A via a network 3. A content manager 1B is the same device as the content manager 1A and forms a single system together with the user terminals 2A, . . . , that are permitted access in advance. Here, “content” refers to data files of various data formats such as text, images, and audio, etc., that can be managed using a terminal that can be connected to the network.

When the content manager 1A receives a content request for content that is not listed in its own content list, the content manager 1A transfers the content request to the content manager 1B and makes a query as to the whereabouts of the content. The content manager that is the transfer destination of the content request is decided in advance between the content managers. The content manager 1A manages correspondence between the user terminals 2X, 2Y, 2Z, logged previously into the content manager 1A and content entered by the user terminal 2, monitors the connection conditions and utilization conditions at the user terminal 2, transmits content that it itself holds with respect to content requests from the user terminal 2, and notifies the user terminal 2, that is the request source, of information to connect to where the content is held. The user terminal 2 is a terminal capable of logging into the content manager 1A and acquires content from the content manager 1A or from other user terminals 2 by making entry of content held by the user into the content manager 1A and by sending a desired content request to the content manager 1A.

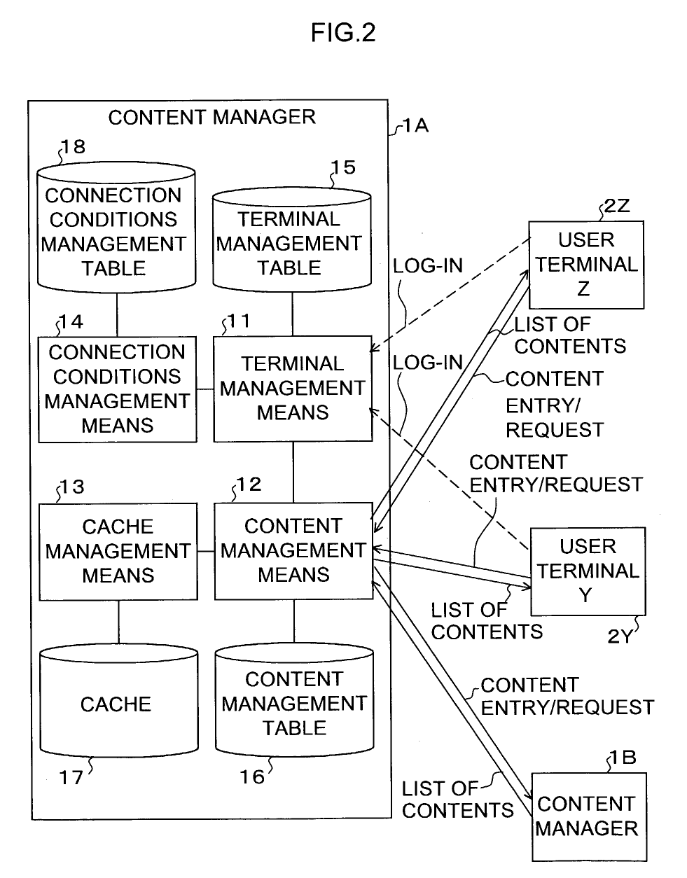

FIG. 2 shows the example configuration for a content manager and the relationship of correspondence between a content manager and user terminals. The content manager 1A is equipped with terminal management means 11, content management means 12, cache management means 13, connection conditions management means 14, a terminal management table 15, a content management table 16, cache 17 and a connection conditions management table 18.

The terminal management means 11 monitors the connection conditions and utilization conditions of the user terminal 2 for storage in the terminal management table 15, and determines whether the user terminal 2 is in the on-line or the off-line state. The terminal management table 15 is a storage area for storing information relating to user terminals 2 logged into the content manager 1A. In addition to information relating to connection conditions, such bandwidth, IP address and the like, the terminal management table 15 stores, for example, the name of the user of user terminal 2 and authentication information, if necessary. Then, the terminal management means 11 selects the most appropriate user terminal 2 from the on-line user terminals 2 taking the bandwidth and request wait states of the user terminals 2 stored in the connection conditions management table 18 as factors. Further, when the request destination goes off-line state during content transfer, the terminal management means 11 switches a further user terminal 2 that is in the on-line state and holds the same content over to being the content request destination in order to continue the content transfer.

The content management means 12 is means for receiving entry of content from user terminals 2 and managing the whereabouts of content that is the request target, i.e. managing on which user terminal 2 the corresponding content exists, based on the content management table 16. The content management means 12 manages the data name, size and hash value of content possessed by the user terminal 2. The hash value is used to determine sameness of content. This is because the user is able to assign a content title (a data name) in an arbitrary manner, and if the data name is changed it is not possible to determine whether or not content is the same with only the data name. The hash value is calculated by the content management means 12 at the time of acquiring content of information relating to the content using a related method. This is by no means limited to a hash value, and other information or values other than the data name which is capable of identifying the content may also be used.

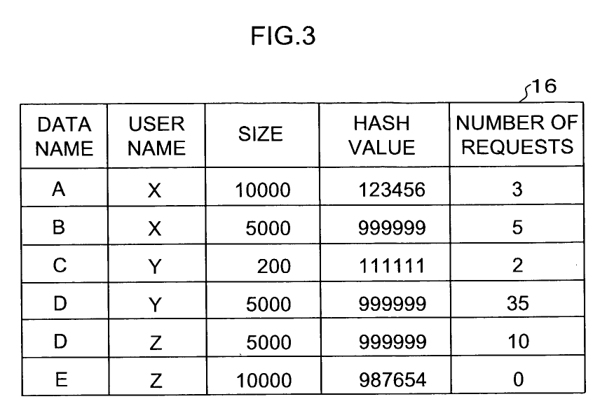

The content management table 16 is a storage area for storing information specifying the content entered by the user terminal 2 and information specifying the registrant of the user terminal 2 in a corresponding manner. FIG. 3 shows an example of the content management table 16. The content management table 16 comprises data name, user name, size, hash value, and number of items requested. The data name is the name of content belonging to the user terminal 2, the user name is the name of the user of the user terminal 2, the size is the size (capacity) of the content, and the number of requests is the number of connection requests made by the whole system for this content. For example, in FIG. 3, the size and hash value of the content (content B) of data name “B” and the content (content D”) of data name “D” are the same. The content management means 12 therefore determines content C and content D to be the same.

The cache management means 13 is means for determining whether or not content entered for the user terminal 2 is stored in the cache 17 based on the content size, connection conditions and the like, and for managing the cache 17 for temporarily storing the content. The cache management means 13 stores the corresponding content in the cache 17, when the size of the content is in excess of a fixed capacity, when the number of requests for the content is large, when a rate of on-line state (described later, the proportion of time spent connected to the network) of the user terminal 2 possessing the content is low, for example. When the number of requests for the content drops after a fixed period of time, the corresponding content is deleted from the cache 17.

The connection conditions management means 14 is means for acquiring the connection log of the user terminal 2, statistically processing the connection conditions of the user terminal 2 based on data relating to the connection conditions stored in the connection conditions management table 18, and obtaining the connection timing, the rate of on-line state or the like of the user terminal 2 that is the destination of the content request. The connection conditions management means 14 enters the time the user terminal 2 is connected to the network for example, daily, or on a time of day basis, estimates the time span when the user terminal 2 is likely to be next in the on-line state, and calculates the rate of on-line state.

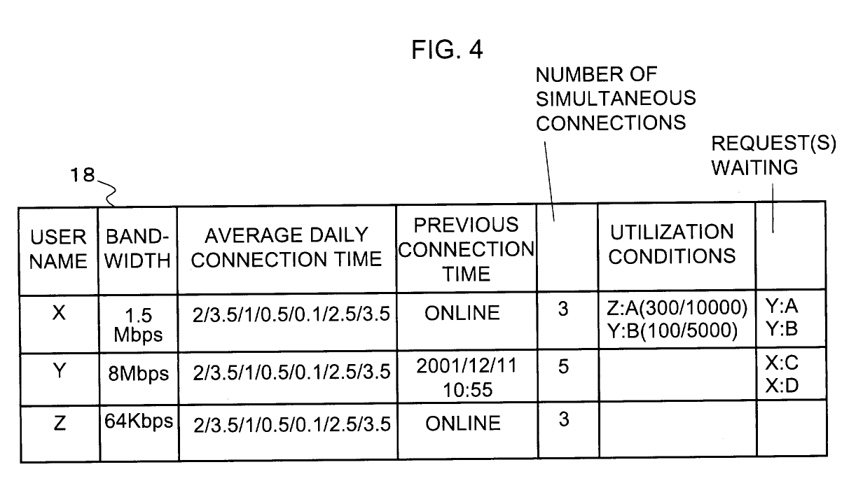

FIG. 4 shows example of the connection conditions management table 18. The connection conditions management table 18 comprises the user name, bandwidth, average daily connection time, previous connection time, number of simultaneous connections, utilization conditions, and items awaiting request. The bandwidth is a value showing the bandwidth used by connecting the user terminal 2. The average daily connection time is a value calculated daily for the average time the user terminal 2 is connected to the network 3. The previous connection time is the time the user terminal 2 was most recently connected to the network. An “on-line” status is set for a user terminal 2 that is in the on-line state. The number of simultaneous connections is the maximum number of user terminals 2 that a user terminal 2 can be simultaneously connected to. The utilization conditions is various information relating to the conditions for connecting to the network and is data such as, for example, the user name of a user terminal 2 to which the user terminal 2 is connected, the data name of content being transferred, the content capacity and the capacity upon completion of the transfer. Request waiting stores the user terminal 2 which is requested to be connected to the user terminal 2 and the data name of the request content.

The example shown in FIG. 4 shows that user terminal 2X of user name “X” is using 1.5 Mbps of bandwidth and is in the on-line state. It is also shown that user terminal 2X is in the middle of transferring content A to user terminal 2Z of user name “Z”, and that transfer has been completed for 300 MB of 10000 MB content. It is further shown that user terminal 2X is in the middle of transferring content B to user terminal 2Y of user name “Y”, and that transfer has been completed for 100 MB of 5000 MB content. Moreover, for user terminal 2X, requests for content A and content B of user terminal 2Y are shown to be waiting. The average daily connection times for each day of the week (2/3.5/1/0.5/0.1/2.5/3.5) are average numbers of hours spent on-line for one day acquired from the log information for the user terminal 2X shown for each day from Monday to Sunday, so that, for example, the average time for Monday is two hours.

A description of the flow of the processing of the present invention is given using FIG. 1. The user terminal 2X logs in to the terminal management means 11 of the content manager 1A and enters the user name. The terminal management means 11 stores the user name “X” of the user terminal 2X and the connection environment or the like such as the IP address in the terminal management table 15. The user terminal 2X then transmits an entry request (entry) appended to a list for the content A, content B and so on, and enters the content. The content management means 12 then receives the content entry request and the content entry list (data name, size, and the like), calculates hash values for each content, adds the contents of the content entry list and the calculated hash values to the content management table 16 and registers the content.

It is then assumed that a user terminal 2 capable of accessing the content manager 1A sends a content request specifying the content C to the content management means 12. The content management means 12 then searches the content management table 16 taking the table name “C” of the content request as a search key and extracts a record for the data name “C”. The content management table 16 is then searched taking the size and hash value of the extracted record for the content C as a search key, and a record that has a data name different to that of the content C but is deemed to have the same content is extracted. In the case of the content management table 16 shown in FIG. 3, for example, there is no other content for which both size and hash value are the same and the content management means 12 therefore does not extract a record. The content management means 12 then passes the data name of the extracted record over to the cache management means 13.

The cache management means 13 then searches the content list taking the data name “C” as a key to determine whether or not there is content that is the same as the content C in the content stored in the cache 17. The cache management means 13 then ends processing because the content C is not held in the cache 17. If the content C is held in the cache 17, the cache management means 13 sends the content C to the user terminal 2Z.

The content management means 12 passes the user name “Y” for the record for the extracted content C over to the terminal management means 11 and makes a query as to whether or not the user terminal 2Y is in the on-line state or in the off-line state. The terminal management means 11 then searches the terminal management table 15 and returns the status of the user terminal 2Y. If the user terminal 2Y is in the on-line state, the content management means 12 notifies the user terminal 2Z that is the origin of the request of the user Y (user terminal 2Y) possessing the content C and that the user Y is in the on-line state.

When a content request confirmation is received from the user terminal 2Z, the terminal management means 11 sends a content request (request[Y;C]) for the content C from the user terminal 2Z to the user terminal 2Y. The user terminal 2Y then starts transfer of the content C to the user terminal 2Z. When, for example, a plurality of user terminals 2 are detected as possessing the content C, the terminal management means 11 selects the most appropriate user terminal 2 from the user terminals 2 that are on-line based on the bandwidth and the request waiting conditions and sends the content request to this user terminal 2.

When the user terminal possessing the content C goes the off-line state during transfer of the content C, the terminal management means 11 switches a further user terminal 2 that is in the on-line state and carries the same content over to being the content request destination in order to continue the content transfer.

On the other hand, if the user terminal 2Y is in the off-line state, the content management means 12 passes the user name “Y” of the record for the extracted content C over to the user terminal 2Y and the connection conditions management means 14. The connection conditions management means 14 searches the connection conditions management table 18 taking the user name “Y” as a key, extracts records such as connection conditions and utilization conditions (standby, average daily connection time, previous connection time, time, number of simultaneous connections, utilization conditions, request waiting) for the user Y (user terminal 2Y) and returns these to the content management means 12. The content management means 12 then notifies the user terminal 2Z of the connection conditions and utilization conditions for the user terminal 2Y returned by the connection conditions management means 14.

Referring to the notified information, the user 2Z selects a time band or day where the probability of the user 2Y being in the on-line state is high, and then either manually or automatically sends a content request (request[Y;C]) for the content C for the user terminal 2Y to the content manager 1A. The content management means 12 receives this content request, and if the user terminal 2Y is in the on-line state, a content request (request[Y;C]) for the content C is sent from the user terminal 2Z to the user terminal 2Y.

On the other hand, if the user terminal 2Y is in the off-line state, the content management means 12 gives notification that there has been a content request for the content C to the connection conditions management means 14. The connection conditions management means 14 then enters the notified content request in the request waiting for the content C of the user Y in the connection conditions management table 18.

The user terminal 2A capable of accessing the content manager 1B then attempts to send the content request (request[Y;C]) to the content manager 1B. However, the content manager 1B cannot execute the content request and the content request is therefore transferred to a predetermined content manager 1A, with the processing carried out thereafter being the same.

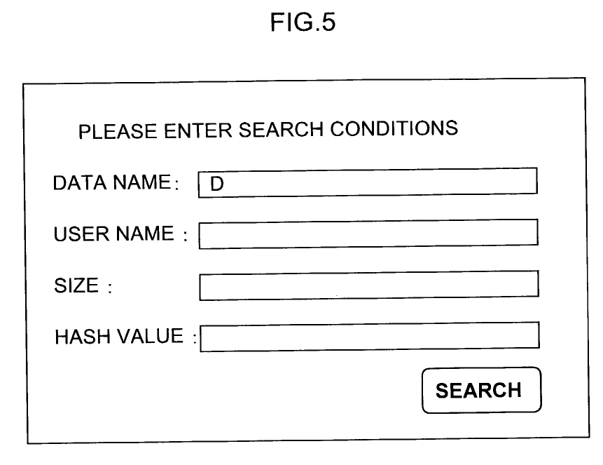

FIG. 5 to FIG. 9 show examples of screens displayed at the user terminal 1. An example is taken where there is a content request for content D made from a user terminal 2 capable of logging into the content manager 1A. An example of a request window for specifying content requested by the user is shown in FIG. 5. At the request window of FIG. 5, the user inputs information specifying content to be requested. It is necessary to specify the content by at least inputting the data name and user name but it is also preferable for the content requested to be specified as far as is possible with information that the user may know such as the size and hash value, etc. The case where data name “D” is inputted is shown here.

At the user terminal 2, a content request is created using the data name inputted using the window of FIG. 5 and is sent to the content manager 1A. The content management table 16 of FIG. 3 is then searched at the content management means 12 of the content manager 1A taking the data name “D” as a key, for example. Using the data name, data size and hash value, two items of content are extracted of the same data name, and one content that is assumed to be the same is also extracted.

The connection conditions and utilization conditions of each of the user terminals 18 possessing the extracted content is then acquired from the connection conditions management table 18 shown in FIG. 4 taking the user name of the extracted content as a key. The acquired connection conditions and utilization conditions are then displayed at the user terminal 2 that is the source of the request via the content management means 12.

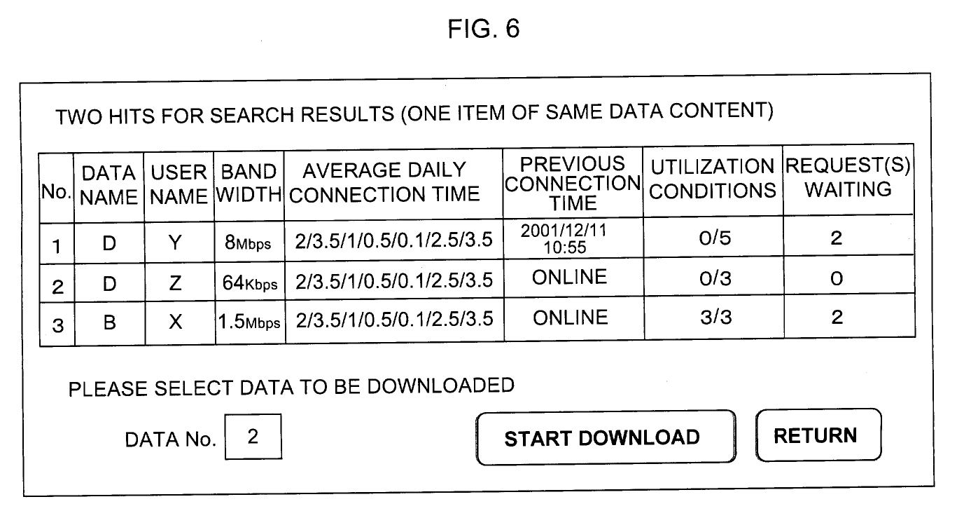

An example of a search results window is shown in FIG. 6. In the search results window of FIG. 6, the user inputs the item number indicating the user terminal content it is wished to download from the list of user terminals possessing the content of the search results, and a download start button is clicked. In doing so, a content request (request[Z;D]) allotted to user terminals 2 of names of users possessing the selected content is created and sent to the content manager 1A. When it is wished to re-execute the specifying of the content request, the return button is clicked and the search results window is closed. When the content request (request[Z;D]) is received at the content manager 1A, the connection conditions and utilization conditions of the user terminal 2Z are determined based on the terminal management table 15 and the connection conditions management table 18, and different windows are then displayed according to these results. At the search results window of FIG. 6, when content No. 1 is selected, the user of user terminal 2Y is off-line and a content request is added to the request waiting of the connection conditions management table 18.

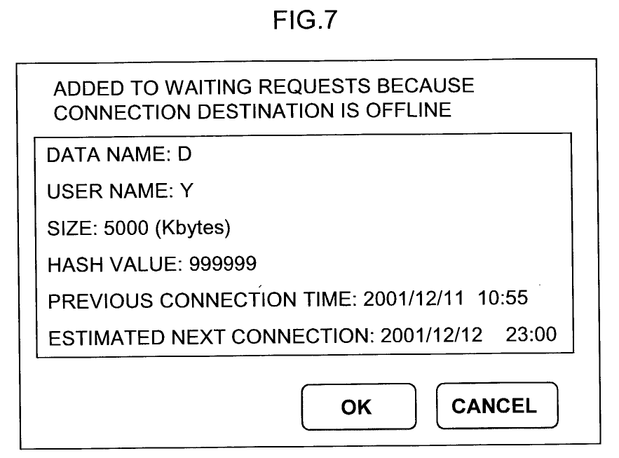

FIG. 7 shows an example window for when connection is awaited shown when the user terminal is in the off-line state. At the window in FIG. 7, a previous connection time monitored by the connection conditions management means 14 and a estimation (time) for the next connection calculated based on data of the connection conditions management table 18 and log data at the connection conditions management means 14 are displayed together with content information such as the data name, user name and hash value etc. The content request is then added to the awaiting requests of the connection conditions management table 18 as a result of clicking the OK button of the window of FIG. 7. At the search results window of FIG. 6, when content No. 2 is selected, the user of user terminal 2Z is in the on-line state and no other people are connected and a connection is therefore commenced immediately.

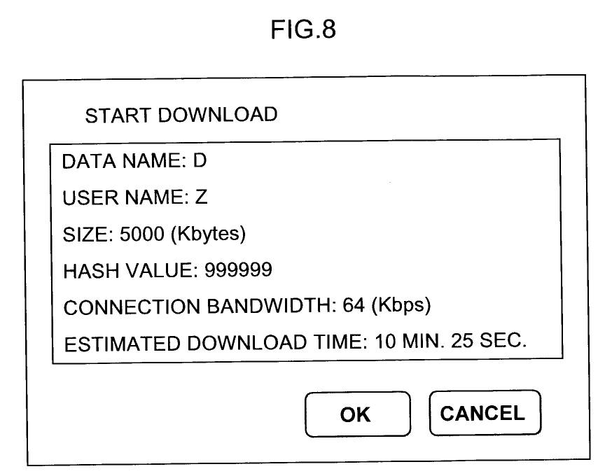

FIG. 8 shows an example window for when the user terminal is on-line and it is possible to start connection. An estimation time for downloading calculated by the connection conditions management means 14 from the bandwidth and the size of the content is then displayed on the window of FIG. 8. When the OK button is clicked on the window of FIG. 8, a content request is immediately sent to the user terminal 2Z based on the connection conditions displayed at the window and connection is started. When content No. 3 is selected at the search results window of FIG. 6, the user of user terminal 2X is in the on-line state but a number of simultaneous connections is also being made and there are also requests waiting. Connection is therefore not started immediately and the request waits.

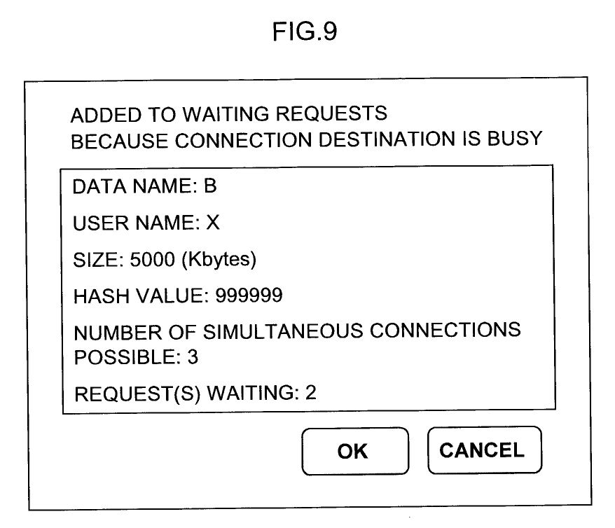

FIG. 9 shows an example window for when the user terminal 2X is on-line and connection is awaited. FIG. 9 shows the number of requests that are waiting that are managed by the connection conditions management means 14. When the OK button is clicked on the window of FIG. 9, the content request is added to the waiting requests of the connection conditions management table 18 based on the connection conditions displayed at the window.

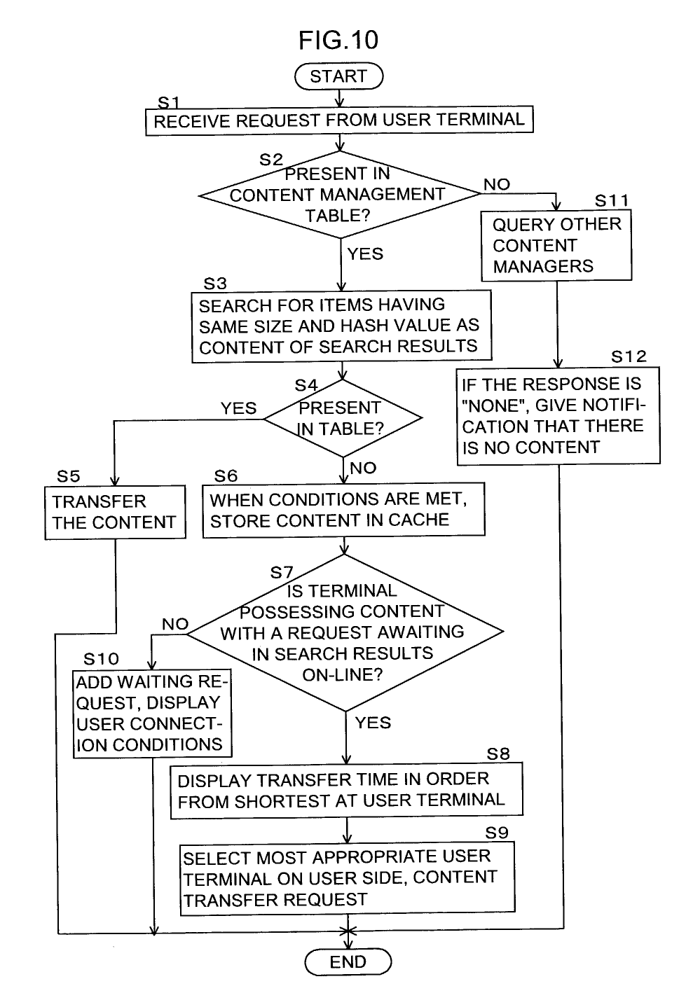

FIG. 10 shows the process flow of the present invention. At the content manager 1A, when the content management means 12 receives a content request from the user terminal 2 (step S1), a check is made as to whether or not content of the same data name exists in the content management table 16 taking the data name of the content in the content request as a search key (step S2). If content of the same data name exists in the content management table 16, a search is then made at the content management table 16 as to whether content having the same size and hash value is present in the content of the search results (step S3). If such content exists in the content management table 16 (step S4), a transfer is made from the user terminal 2 possessing the corresponding content to the user terminal 2 that is the source of the request.

Further, if this is saved in the cache 17 of the content manager 1A, the content is transferred to the user terminal 2 where the request originates by the cache management means 13 (step S5). If there is no such content in the content management table 16 (step S4), the cache management means 13 is notified, and if there is correspondence with the conditions, the corresponding content is saved in the cache 17 (step S6).

A check is then made as to whether or not user terminals possessing the content of the search results or possessing the content requests are waiting for are in the on-line state (step S7). If they are in the on-line state, user terminals possessing the requested content are displayed at the user terminal 2 that is the source of the request in order of shortest transfer time based on the bandwidth and requests waiting conditions (step S8). The most appropriate user terminal is then selected at the displayed screen at the user terminal 2 and a content transfer request is sent (step S9). If the user terminal of the owner of the requested content is not in the on-line state, this request is added to the waiting requests of the connection conditions management table 18 and the connection conditions of the user terminal 2 owning the content are displayed at the user terminal 2 where the request originates (step S10).

When, in the process in step S2, the requested content does not exist in the content management table 16, another content manager 1B is queried (step S11). If there is a reply to the effect that there is no such content from the content manager B, the user terminal 2 where the request originates is notified that there is no such content (step S12).

As described above, according to the present invention, a data name, size and hash value of content held by a user terminal is stored in advance in a content management table corresponding to the user terminals. When a content request is then made, the same content is extracted using data for the request target as a key and content of the same size and hash value is extracted.

In this way, even if user terminals holding the content are in the off-line state, it is possible to request the content from other user terminals, the amount of content it is possible to acquire is substantial, and it is possible to exchange data in an effective manner even between terminals for which the probability of being in the on-line state is low. Further, by performing handling in such a manner that content with the same hash value has the same contents, the likelihood of a user overlooking the whereabouts of the desired content is lower and the acquisition of content is made much more straightforward. The present invention also manages the storage of connection conditions of the user terminals. Estimation of the time bands where the user can acquire the desired content is therefore possible.

In the above, a description is given of practical implementations of the present invention but various modifications are possible within the scope of the present invention. It is also possible for each of the processing steps, processing means, and elements of the present invention to be implemented by a program executed on a computer. The program implementing the present invention may be stored on an appropriate recording medium readable by computer such as portable memory media, semiconductor memory, or a hard disc, etc., and may be provided through recording on such a recording media, or through exchange utilizing various communications networks via a communications interface.

What is claimed is:

1. A data acquisition system for carrying out acquisition of data between terminals on a network, comprising:
a data management table for storing data held by terminals in such a manner that terminals holding the data correspond;
terminal management means for determining whether or not a data acquisition request source terminal and a request destination terminal are in an on-line state of being connected to the network, or are in an off-line state of not being connected to the network;
connection conditions management means for acquiring a connection log for the request destination terminal and managing connection conditions for each item of data of the request destination terminal;
data management means for, when a data acquisition request is received from the request source terminal, extracting the terminal holding target data of the data acquisition request as a request destination terminal, and when the request destination terminal is in an on-line state, sending the data acquisition request to the request destination terminal and starting transfer of the request target data, and when the request destination terminal is in an off-line state, holding the data acquisition request as a waiting request, acquiring connection conditions corresponding to the request destination terminal, and sending the connection conditions to the request source terminal.

2. The data acquisition system of claim 1, wherein the data management table stores a data name, size and hash value of data possessed by the terminals, and the data management means extracts a terminal holding data that is the same size and hash value as the target data of the data acquisition request as a request destination terminal.

3. The data acquisition system of claim 1, wherein when a plurality of request destination terminals in the on-line state are present, the terminal management means selects a request destination terminal of the shortest transfer time as a request destination terminal based on bandwidth and waiting requests of the request destination terminals.

4. The data acquisition system of claim 1, wherein when it is detected during data acquisition that the request destination terminal has gone to an off-line state, the terminal management means switches the data acquisition request over to a further request destination terminal in an on-line state holding the same data as the data acquisition request target data.

5. The data acquisition system of claim 1, wherein the connection conditions management means records the time the request destination terminal is connected to the network daily or on a time-of-day basis as the connection conditions, and obtains a daily or time-of-day basis average connection time for the request destination terminal from the network connection times and obtains a probability of being on-line state for the request destination terminal.

6. The data acquisition system of claim 1, wherein the connection conditions management means records the time the request destination terminal is connected to the network daily or on a time-of-day basis as the connection conditions, and estimates a time span when the request target terminal is next likely to be in an on-line state from the network connection times.

7. The data acquisition system of claim 1, further comprising cache management means for temporarily holding data entered at terminals based on the size of the data entered at the terminals and connection conditions with respect to the data.

8. A program for executing on a computer data acquisition processing for carrying out acquisition of data between terminals on a network, comprising:
process for storing data held by terminals in a data management table for in such a manner that terminals holding the data correspond;
terminal management process for determining whether or not a data acquisition request source terminal and a request destination terminal are in an on-line state of being connected to the network, or are in an off-line state of not being connected to the network;
connection conditions management process for acquiring a connection log for the request destination terminal and managing connection conditions for each item of data of the request data destination terminal;
data management process for, when a data acquisition request is received from the request source terminal, extracting the terminal holding target data of the data acquisition request as a request destination terminal, and when the request destination terminal is in an on-line state, sending the data acquisition request to the request destination terminal and starting transfer of the request target data, and when the request destination terminal is in an off-line state, holding the data acquisition request as a waiting request, acquiring connection conditions corresponding to the request destination terminal, and sending the connection conditions to the request source terminal.

9. The data acquisition program of claim 8, wherein a data name, size and hash value of data possessed by the terminals are stored in the data management table; and the data management process extracts a terminal holding data that is the same size and hash value as the target data of the data acquisition request as a request destination terminal.

10. The data acquisition program of claim 8, wherein, when a plurality of request destination terminals in an on-line state are present, the terminal management process selects a request destination terminal of the shortest transfer time as a request destination terminal based on bandwidth and waiting requests of the request destination terminals.

11. The data acquisition program of claim 8, wherein, when it is detected during data acquisition that the request destination terminal has gone off-line state, the terminal management process switches the data acquisition request over to a further request destination terminal in an on-line state holding the same data as the data acquisition request target data.

12. The data acquisition program of claim 8, wherein the connection conditions management process records the time the request destination terminal is connected to the network daily or on a time-of-day basis as the connection conditions, and obtains a daily or time-of-day basis average connection time for the request destination terminal from the network connection times and obtains a probability of being on-line for the request destination terminal.

13. The data acquisition program of claim 8, wherein the connection conditions management process records the time the request destination terminal is connected to the network daily or on a time-of-day basis as the connection conditions, and estimates a time span when the request target terminal is next likely to be in an on-line state from the network connection times.

14. The data acquisition program of claim 8, further comprising cache management process for temporarily holding data entered at terminals based on the size of the data entered at the terminals and connection conditions with respect to the data.

15. A data acquisition program recording medium recorded with the data acquisition program for executing on a computer data acquisition processing for carrying out acquisition of data between terminals on a network, wherein the data acquisition processing comprising:
process for storing data held by terminals in a data management table for in such a manner that terminals holding the data correspond;
terminal management process for determining whether or not a data acquisition request source terminal and a request destination terminal are in an on-line state of being connected to the network, or are in an off-line state of not being connected to the network;
connection conditions management process for acquiring a connection log for the request destination terminal and managing connection conditions for each item of data of the request data destination terminal;
data management process for, when a data acquisition request is received from the request source terminal, extracting the terminal holding target data of the data acquisition request as a request destination terminal, and when the request destination terminal is in an on-line state, sending the data acquisition request to the request destination terminal and starting transfer of the request target data, and when the request destination terminal is in an off-line state, holding the data acquisition request as a waiting request, acquiring connection conditions corresponding to the request destination terminal, and sending the connection conditions to the request source terminal.

16. The data acquisition program recording medium of claim 15, wherein a data name, size and hash value of data possessed by the terminals are stored in the data management table; and the data management process extracts a terminal holding data that is the same size and hash value as the target data of the data acquisition request as a request destination terminal.

17. The data acquisition program recording medium of claim 15, wherein when a plurality of request destination terminals in an on-line state are present, the terminal management process selects a request destination terminal of the shortest transfer time as a request destination terminal based on bandwidth and waiting requests of the request destination terminals.

18. The data acquisition program recording medium of claim 15, wherein when it is detected during data acquisition that the request destination terminal has gone off-line state, the terminal management process switches the data acquisition request over to a further request destination terminal in an on-line state holding the same data as the data acquisition request target data.

19. The data acquisition program recording medium of claim 15, wherein the connection conditions management process records the time the request destination terminal is connected to the network daily or on a time-of-day basis as the connection conditions, and obtains a daily or time-of-day basis average connection time for the request destination terminal from the network connection times and obtains a probability of being on-line for the request destination terminal.

20. The data acquisition program recording medium of claim 15, wherein the connection conditions management process records the time the request destination terminal is connected to the network daily or on a time-of-day basis as the connection conditions, and estimates a time span when the request target terminal is next likely to be in an on-line state from the network connection times.

21. The data acquisition program recording medium of claim 15, further comprising cache management process for temporarily holding data entered at terminals based on the size of the data entered at the terminals and connection conditions with respect to the data.
